(19) United States
(12) Patent Application Publication
(10) Pub. No.: US 2005/0125842 A1
(43) Pub. Date: Jun. 9, 2005

(54) Modular set top box

(75) Inventors: Eric Calmels, Caen (FR); Eric Desmicht, Caen (FR); Lodewijk F. Mijnssen, Caen (FR)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKILJKE ELECTRONICS N.V.

(21) Appl. No.: 10/508,963

(22) PCT Filed: Mar. 17, 2003
(86) PCT No.: PCT/IB03/01002

(30) Foreign Application Priority Data
Mar. 22, 2002 (EP) 02290738.0

(51) Int. Cl. H04N 7/173; G06F 9/44

(52) U.S. Cl. 725/132; 725/100; 717/168; 717/172; 717/173

(57) ABSTRACT

The invention consists to propose an ultra low cost basic set top box with extension module connection possibility. Instead of proposing one STB for each market, which increase the overall costs, only one STB is marketed. In addition of this unique referenced STB, a set of modules are proposed. To connect the modules, different solutions are possible. As the high volume is based on the basis STB, the cost of the add-on module has to be very low. The solution consists in a card-edge board to board connector, where the connector is on the module, and not on the STB. As consequences the main board will only include contacts footprints. The basic STB can be defined after a marketing study and includes the needed features for High-volumes market. The customer only pays for the features he wants.

The invention relates to a Set-Top-Box (STB) product intended to work in relationship with a Home Phoneline Networking Alliance (Home PNA) network.

### STATE OF THE ART

A set-top box includes mainly the following components
The tuner selects the desired frequency channel, and do a frequency transposition, signal amplification, and filtering
The channel decoding do an analog to digital conversion of the resulting signal, and do a demodulation of the digital signal
The source receiver is mainly composed of a descrambler and demultitiplexer, an MPEG audio and graphic composition decoding, audio peripherals digital to analog conversion, video output PAL/SECAM with OSD, a CPU with memory interface (ROM, Flash or/and DRAM) and some other bus peripheral interface (USB, PC1, 1²C, UART, 1EE1394) . . .
A software abstraction layer (called “middleware”) between hardware and platform independent software, plus an application software
Conditional access components (Smart-card), to protect the broadcaster revenues.

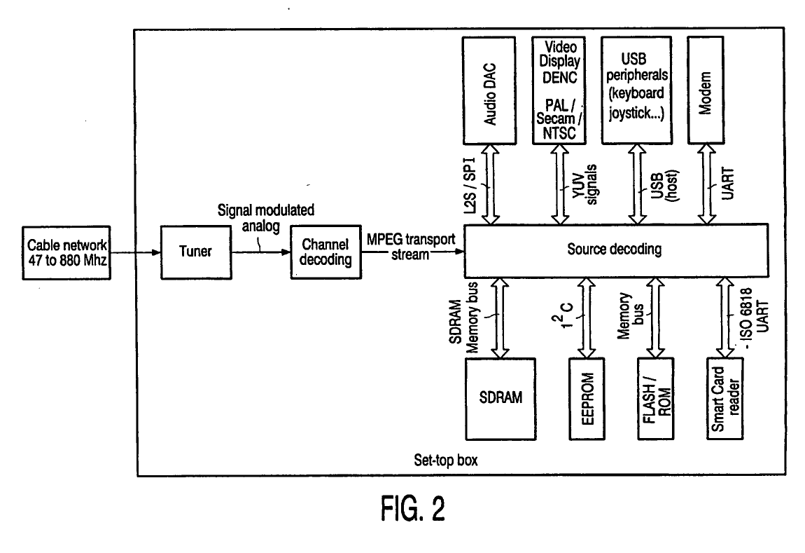

FIG. 2 is an overview of such a typical STB product architecture.

The invention relates to a STB product having at least one module connection possibility.

The PCT patent application NoW0 01/74079 describes a STB product including a plurality of modular functional blocks. These modular blocks are placed in relation with a main board of the STB product during production phase in industry. According this document, a single generic bus PCI performs the link between said modular blocks and the main board of the STB product. The aim of this invention is to simplify the production of STB product itself and to offer flexibility and adaptability of the production process. But on the market itself, STB products are declined and distributed in high-end, medium-end and low-end products with corresponding features. High-end ones are more expensive and present more functionalities than medium-end ones that are more expensive and present more functionalities than low-end ones. The STB products market is consequently fractionated. Moreover, even low-end products have to include a minimum of functionalities; to attract clients. These functionalities imply a cost and resulting low-end STB products are quite expensive anyway. This is a problem for markets on which clients are not oriented towards the kinds of features a STB product provides. Even the low-end products seem not to be attractive on such markets as prices are too large regarding to the limited features it provides.

A purpose of the invention is to provide a very low STB product able to be adapted to the client needs.

A STB product having at least one module connection possibility a basic STB product having basic functions implemented on a main circuit board in the STB product and means for connecting at least a separated modular block including new features for the STB product according to the invention as said STB product is characterized in that said means for connecting are compatible with several different kinds of modular blocks able to carry out different groups of features, said modular blocks being sold as different packs to end-users.

Client needs evolve in time. At the beginning a client can be interested in a basic STB product that would allow him to get familiarized with such products. Such a basic product is very cheap and is able to only perform simple operations defined after a marketing study on each concerned markets. Consequently such a STB product is intended to be spread on very high-volume market. As clients can each personalize their own STB product at the rhythm and the height they, each, wish, such a basic STB would be effectively sold in great quantity. The invention concerns also a separated modular block able to carry out a group of features intended to update a STB product having basic functions implemented on a main circuit board in the STB product, characterized in that said modular block is sold as a pack to end-users, said modular block being intended to be plugged to the main circuit board of the STB product by an end-user himself with means of connection, said means of connection being compatible with different kinds of modular blocks carrying out different groups of features.

The invention concerns also a method for updating with new features a STB product having basic functions implemented on a main circuit board in the STB product, said features being included in separated modular blocks characterized in that several different kinds of modular blocks able to carry out different groups of features are sold as different packs to end-users and are intended to be plugged to the main circuit board of the STB product by end-users themselves with an unique kind of means of connection for all kinds of modular blocks.

The invention consists to propose an ultra low-cost basic set-top box with extension module connection possibility.

The basic set-top box is defined after a marketing study, and includes the needed features for High-volume market. So, the customer pays only for the features he wants, and for example, 80% of the market will be constituted with basic set-top box, the remaining 20% will use high end function.

Instead of proposing one set-top box different for each market, which increase the overall costs customer and manufacturing, only one set-top box is marketed. In addition to this unique referenced set-top box, a set of modules are proposed.

To connect the module, different solutions are possible. As the high volume is based on the basis set-top box, the cost of the add-on module as to be very low. The solution, then consists to propose a card-edge board to board connector, where the connector is on the module, and not on the STB. As consequences the main board will only include contacts footprints.

According to an implementation of the invention, means of connection are performed by a female connector on the modular block side and by an emulated and metalized part of the main board on the STB product side.

This implementation allows having a very low cost STB product with cheap means of connection. Effectively, to emulate and metalize a printed board is very cheap comparing to add a connector on said main board. In effect, emulated and metalized part serves as a male connector. In the case the main board carry a male connector realized by emulating and metalizing a part of the main board, a female connector has nevertheless to be implemented on the modular block. It increases the price of the module. But as the invention aim to First sell STB products and only then, different kinds of modular blocks. The price of the modular block can be increased. Effectively as soon as a basic STB product is bought, buying at least a modular block is the logical following and users are tempted to buy it. With the invention, the global price can be higher than an equivalent STB product having fixed features, as buying a STB product in two times, said STB product being moreover susceptible to be customized, is easier for client than buying a STB product in a single time knowing that this STB product can not be modified.

According to an advantageous implementation of the invention, some specific features among all features carried out by the different kinds of modular blocks have, each, dedicated connection sub-means included in said means of connection, others features sharing the remaining part of said connection means.

Specific features can be the ones that would imply to add an adaptor in the module to render a generic bus able to carry their specific data. These kinds of adaptor are expensive.

Here is an example of characteristics of such an adaptor for a modem connection to an USB generic bus:

USB to Serial Converter

USB to Standard Serial Modem
Led indicator
Compatible Plug & Play
Windows 98/ME/2000/
FIFO UART 16C550 Serial Port
Fully tested and working with Millennium Programmer,
Smart Mouse/Phoenix and Logger/Emulator.

Such adaptors are well known in computer environment applications to plug cards on PC boards and to plug cards to each other.

The price of such an adaptor is in itself as high as the price of the modular block with specific connections sub-means for said modem. The mixed implementation with specific connection means (specific bus) and a generic bus for all other features (for example USB or PCI bus) find here a very relevant advantage. This mixed implementation is realized on the same physical connector as described above.

For example, a smart card reader would benefit from this implementation by having connections intended to carry its characteristic data. An ISO 6816 smart card interface can be for example included in the global connection means.

If differentiated connection means would be provided for these specific features, end-user could be confused by several connectors and not be able to choose one connector to plug the smart card reader. But as this is the user that plugs the modular block, the plugging has to be secured and easy. The invention provides unique means of connection for multiple kinds of modular blocks that can include all possible combination among all possible additional features for a STB product. This could imply damaging inside module and even inside the STB product. A unique kind of means of connection for every possible modular block provides a secured environment at the user side. This characteristic is ignored in the past as modular plugging is done in industrial site. The unique kind of connection means can furthermore is easily protected against electrostatic chock as a single connector or as a single interface.

According to a preferred implementation of the invention, said specific features are included in the group formed by a smart card reader, a modem, a memory, games features, interactive and WebTV features.

The invention will be further described with reference to examples of embodiments shown in the drawings, in which:

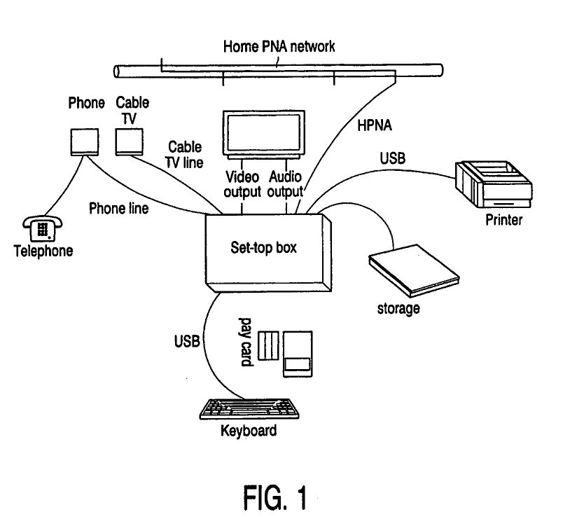

FIG. 1 represents an example of a STB product environment overview,

FIG. 2 is an overview of a typical STB product architecture,

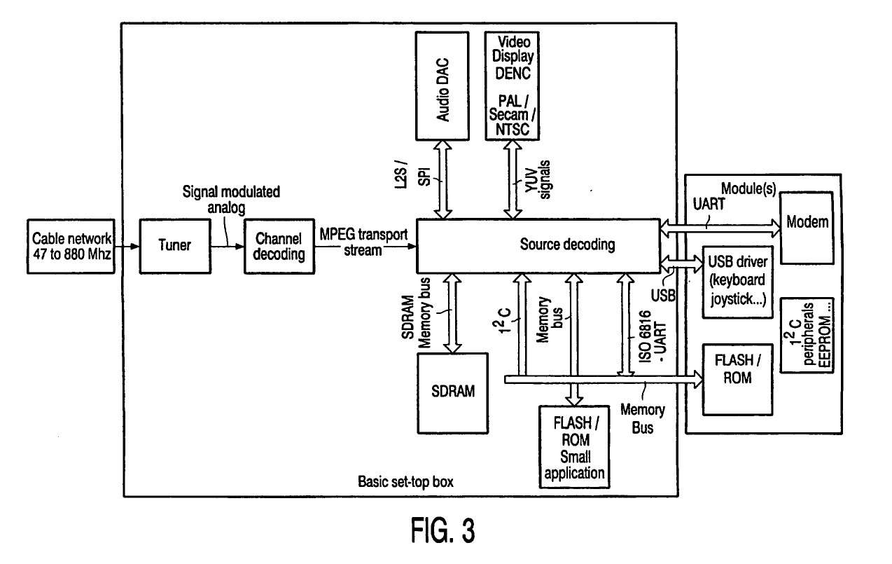

FIG. 3 illustrates a new architecture of a STB product according to the invention with an example of a modular block,

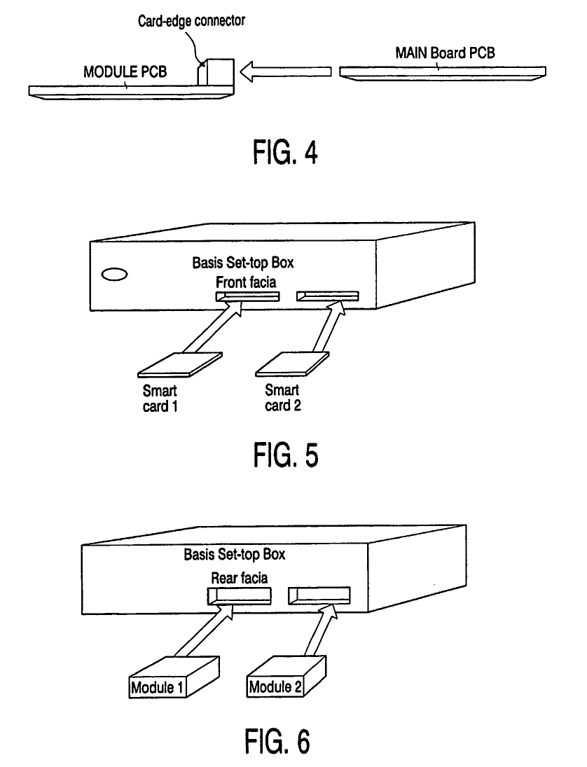

FIG. 4 illustrates an example of connection between a modular block and the main board of a STB product where main board and modular block are coplanar according to the invention,

FIG. 5 illustrates an overview of the modular block connection on the front side of the STB product,

FIG. 6 illustrates an overview of the modular block connection on the rear side of the STB product,

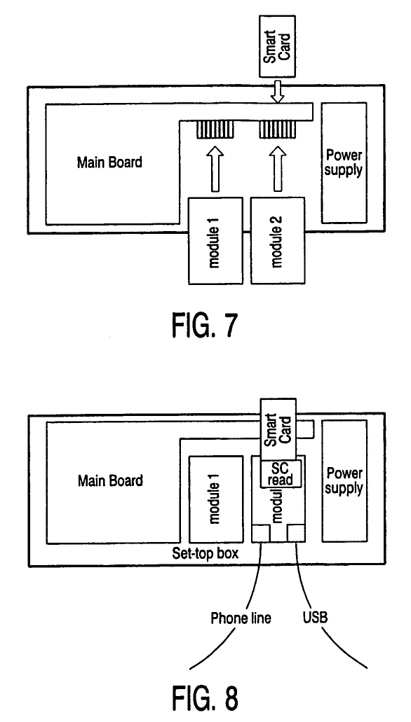

FIG. 7 illustrates an internal top view of the plugging of modular blocks in a STB product with a module dedicated to receive a smart card,

FIG. 8 illustrates a STB product internal top view with plugged modular blocks and with additional means for connecting different networks to the STB,

FIG. 9 illustrates a first parallel connection between a modular block and the main board of the STB product wherein board of the modular block and main board of the STB product are parallel,

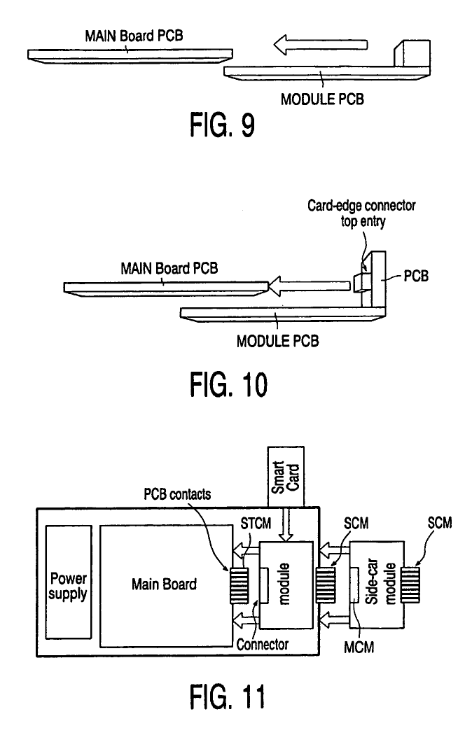

FIG. 10 illustrates a second kind of parallel connection between a modular block and the main board of the STB product,

FIG. 11 illustrates connection by side entry between a first modular block and the main board of the STB product, said first modular block including means for connecting a second “side-car” modular block.

FIG. 1 describes the classical environment of a STB product that is common for classical STB product and STB product according to the invention.

The typical architecture illustrated on FIG. 2 has different inside functional block related to a main board.

The architecture according to the invention presented on FIG. 3, use several specific bus “Uart” and “Memory bus” on the figure. A specific bus for a smart card reader could also be added (ISO 6816). The architecture according to the FIG. 3 uses also a generic bus (“USB” bus on FIG. 3) to transport data relative to all other features that are not specific.

Consequently this structure allows to transport data for specific features on said specific bus, specific features being, for example, the ones for which adaptors are the more expensive ones. Specific features can also be a selection decided during the production of the basic STB after a market study. Effectively, as the main board carries connection means, the connection means have to be configured according to the specific features chosen. The specificity of bus is characterized by their quality, their services, their specific bandwidth . . . . Other features not intended to be implemented in a first time in modular blocks can use generic bus as USB. This implies that the STB product according to the invention is very flexible.

A lot of connection configuration can be used. Some of them are presented in FIGS. 4 to 11. The main board of the STB product and modular blocks can be coplanar, parallel and connections can be performed by the rear side and/or the front side.

As shown on FIG. 8, modular blocks (module) can provide also specific external connection means as a phone return channel (Phone line, external USB . . . ) that is not implemented on the basic STB product and every other feature a STB product can present. Moreover as described on FIG. 11, modular blocks can be plugged to each other in a configuration called “side-car” configuration. In this implementation of the invention, any kind of modular block according to the invention can consequently be plugged in supplementary connection means SCM implemented on each modular block, said supplementary connection means SCM being similar to the ones STCM implemented on the basic STB main board and intended to be plugged with the connection means MCM of the modular blocks, connection means MCM being the ones intended to be plugged with connection means STCM of the STB product in the most simple configuration where a single modular block is plugged.

“Side-car modules” can include for example, a hard disk drive for time shift recording application. . . . Second modular block send a signal in the generic bus to inform the STB main board that it has been plugged. Then as for other module the source decoding main board communicates by the different bus of the interface with all the side-car modular blocks. A specific addressing is used for these communications.

This module have to be installed by the final end customer.

The module feature can include for example:
Smart card conditional access
Credit card (Visa . . . ) reader
Phone return channel
USB
Memory extension (for additional software features)
Peripheral extension (keyboard, joystick, printer . . . )

Some of the features should be accessible from the front panel (smart card), others from the rear panel (phone return channel).

### EXAMPLE OF IMPLEMENTATION

An architecture design of an extension module has been done with a semiconductor chipset composed of:
PNX8310 for the source decoding
TDA 10022 for channel decoding
TDA 8271 for tuner chip

The basic box include a secured access vi PNX8310 (see our French Patent Application no. 0203371 filed on Mar. 19, 2002, not still published).

The extension module consists of a smart-card reader, a flash memory extension of 8 MB for additional middleware and application software and a phone return line for internet access, and instant click pay per view.

The interface between the extension module and basic set-top box is described bellow:
Memory interface 16 bits for peripheral and Nor flash interface
ISO 6816 Smart card interface
RS232 for modem connection
Power supply

The module connector chosen is the AMP ref. 2-557101-1. This is a right angle connector for card edge 80 pins.

In this implementation, the description of the interface between the extension modular blocks and basic STB product lists the specific bus used. A generic bus is advantageously added to these specific bus in order to be able to add any other feature, eventually with the addition of an adaptor. Power supply are the supply of the module and is a part of the communication between the modular blocks and the STB main board. The affectation of connection means signal is fixed when the basic STB product is defined. Every modular means have to respect this affectation to be compatible with said basic STB product. Consequently, the interface is a kind of standard for every module. The interface is defined in order to be compatible with the most complex modular block possible in terms of signals exchanged with the STB main board. The interface does not change with the modular block plugged but data carried by the interface change according to the modular block plugged. For example, basic STB product can include channel decoding means with zapping means and having additional features provided by modular blocks.

1. A method for updating with new features a STB product having basic functions implemented on a main circuit board in the STB product, said features being included in separated modular locks characterized in that several different kinds of modular blocks able to carry out different groups of features are sold as different packs to end-users and are intended to be plugged to the main circuit board of the STB product by end-users themselves with an unique kind of means of connection for all kinds of modular blocks:

2. A method according to claim 1, characterized in that means of connection are performed by a female connector on the modular block side and by an emulated and metalized part of the main board on the STB product side.

3. A method according to claim 1, characterized in that some specific features among all features carried out by the different kinds of modular blocks have, each, dedicated connection sub-means included in said means of connection, others features sharing the remaining part of said connection means.

4. A method according to claim 3, characterized in that said specific features are included in the group formed by a smart card reader, a modem, a memory.

5. A basic STB product having basic functions implemented on a main circuit board in the STB product and means for connecting at least a separated modular block including new features for the STB product, characterized in that said means for connecting are compatible with several different kinds of modular blocks able to carry out different groups of features, said modular blocks being sold as different packs to end-users.

6. A basic STB product according to claim 5, characterized in that an emulated and metalized part of the main board serve as connection means with said modular blocks.

7. A basic STB product according to claim 5, characterized in that some specific features among all features carried out by the different kinds of modular blocks have, each, dedicated connection sub-means included in said means of connection, others features sharing the remaining part of said connection means.

8. A separated modular block able to carry out a group of features intended to update a STB product having basic functions implemented on a main circuit board in the STB product, characterized in that said modular block is sold as a pack to end-users, said modular block being intended to be plugged to the main circuit board of the STB product by an end-user himself with means of connection, said means of connection being compatible with different kinds of modular blocks carrying out different groups of features.

9. A separated modular block according to claim 8, characterized in that a female connector serve as connection means with said STB product.

10. A separated modular block according to claim 8, characterized in that some specific features among all features carried out by the different kinds of modular blocks have, each, dedicated connection sub-means included in said means of connection, others features sharing the remaining part of said connection means.

11. A separated modular block according to claim 8, characterized in that said specific features are included in the group formed by a smart card reader, a modem, a memory.
